(19) United States
(12) Patent Application Publication
(10) Pub. No.: US 2026/0136154 A1
(43) Pub. Date: May 14, 2026

(54) HEAD-MOUNTED DISPLAY AND METHOD FOR COMPENSATING AUDIO DATA

(71) Applicant: HTC Corporation, Taoyuan City (TW)

(72) Inventors: Li-Yen Lin, Taoyuan City (TW); Yan-Min Kuo, Taoyuan City (TW)

(73) Assignee: HTC Corporation, Taoyuan City (TW)

(21) Appl. No.: 18/948,402

(22) Filed: Nov. 14, 2024

(51) Int. Cl. H04S 7/00; G06T 7/50; G06T 7/70; G06V 10/774

(52) U.S. Cl. CPC H04S 7/305; G06T 7/50; G06T 7/70; G06V 10/774; G06T 2207/20081

(57) ABSTRACT

A head-mounted display and method for compensating audio data are provided. The method includes: obtaining a plurality of room impulse responses; capturing an image of a field; performing image recognition on the image according to a machine learning model to obtain field type information; selecting a first room impulse response from the plurality of room impulse responses according to the field type information; processing audio according to the first room impulse response to obtain processed audio; and outputting the processed audio.

### BACKGROUND

### Technical Field

The disclosure relates to an extended reality (XR) technology, and particularly relates to a head-mounted display and method for compensating audio data.

### Description of Related Art

It is assumed that a sound source and a listener are in the same space. When the sound source emits sound, the sound waves travel through vibrations in the air. The volume of air expands or contracts due to the sound waves to form density waves. The density waves are transmitted to the listener's ears, allowing the listener to hear sounds. Different spaces may have different acoustic properties. For example, conference room walls are generally made of glass and lack sound-absorbing materials such as curtains. Therefore, the sound in the conference room has a more obvious reverberation. On the other hand, the size of the space also affects the transmission, reflection or attenuation of sound waves. That is, different spaces may have different room impulse responses (RIRs).

Room impulse response has a significant impact on the listener's experience. In order to make a virtual sound source in an augmented reality (AR) scene provided by a head-mounted display exhibit a realistic effect, the head-mounted display needs to obtain the room impulse response at the user's location before it may use the room impulse response to process audio. However, users may use the head-mounted display anywhere. Therefore, how to ensure that the head-mounted display may provide realistic virtual sound sources in any usage environment is one of the important issues in this field.

### SUMMARY

The disclosure provides a head-mounted display and method for compensating audio data, which may provide users with realistic audio according to the environment of the user.

The disclosure provides a head-mounted display for compensating audio data, including a storage medium, an image capture device, a speaker, and a processor. The storage medium stores a plurality of room impulse responses. The image capture device captures an image of a field. The processor is coupled to the storage medium, the image capture device, and the speaker, where the processor is configured to execute: performing image recognition on the image according to a machine learning model to obtain field type information; selecting a first room impulse response from the plurality of room impulse responses according to the field type information; processing audio according to the first room impulse response to generate processed audio; and outputting the processed audio through the speaker.

In an embodiment of the disclosure, the processor is configured to further execute: measuring a size of the field through the image capture device; and selecting the first room impulse response from the plurality of room impulse responses according to the size and the field type information.

In an embodiment of the disclosure, the processor is configured to further execute: measuring the field through the image capture device to obtain depth information; executing a simultaneous localization and mapping algorithm according to the depth information to obtain grid information; and calculating the size of the field according to the grid information.

In an embodiment of the disclosure, the processor is configured to further execute: performing convolution on the audio and the first room impulse response to generate the processed audio.

In an embodiment of the disclosure, the field type information includes a material of a sound reflector.

In an embodiment of the disclosure, the processor is configured to further execute: receiving a plurality of historical images, where each of the plurality of historical images is tagged with historical field type information; and training the machine learning model according to the plurality of historical images.

A method for compensating audio data of the disclosure includes: obtaining a plurality of room impulse responses; capturing an image of a field; performing image recognition on the image according to a machine learning model to obtain field type information; selecting a first room impulse response from the plurality of room impulse responses according to the field type information; processing audio according to the first room impulse response to obtain processed audio; and outputting the processed audio.

In an embodiment of the disclosure, the step of selecting the first room impulse response from the plurality of room impulse responses according to the field type information includes: measuring a size of the field through an image capture device; and selecting the first room impulse response from the plurality of room impulse responses according to the size and the field type information.

In an embodiment of the disclosure, the step of measuring the size of the field through the image capture device includes: measuring depth information of the field through the image capture device; executing a simultaneous localization and mapping algorithm according to the depth information to obtain grid information; and calculating the size of the field according to the grid information.

In an embodiment of the disclosure, the step of processing the audio according to the first room impulse response to obtain the processed audio includes: performing convolution on the audio and the first room impulse response to generate the processed audio.

In an embodiment of the disclosure, the field type information includes a material of a sound reflector.

In an embodiment of the disclosure, the method further includes: receiving a plurality of historical images, where each of the plurality of historical images is tagged with historical field type information; and training the machine learning model according to the plurality of historical images.

According to the above, the disclosure may compensate the audio data of the virtual sound source according to the field type of the user, making the audio data more realistic.

### BRIEF DESCRIPTION OF THE DRAWINGS

FIG. 1 is a schematic diagram of a head-mounted display for compensating audio data according to an embodiment of the disclosure.

FIG. 2 is a flowchart of a method for compensating audio data according to an embodiment of the disclosure.

FIG. 3 is a flowchart of a method for compensating audio data according to another embodiment of the disclosure.

### DESCRIPTION OF THE EMBODIMENTS

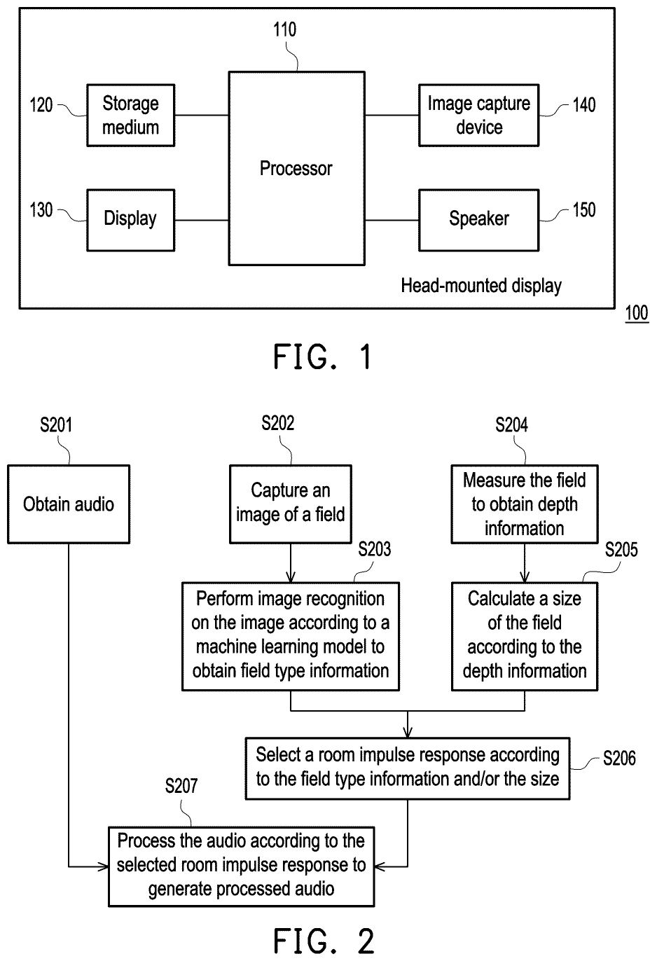

FIG. 1 is a schematic diagram of a head-mounted display 100 for compensating audio data according to an embodiment of the disclosure. The head-mounted display 100 may include a processor 110, a storage medium 120, a display 130, an image capture device 140, and a speaker 150. The head-mounted display 100 may be worn on the user's head, and may provide the user with an XR environment or XR scene, such as a virtual reality (VR) environment, an AR environment, or a mixed reality (MR) environment.

The processor 110 is, for example, a central processing unit (CPU) or other programmable general-purpose or special-purpose micro control units (MCUs), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar elements, or a combination thereof. The processor 110 may be coupled to the storage medium 120, the display 130, the image capture device 140, and the speaker 150, and access and execute a plurality of modules and various application programs stored in the storage medium 120.

The storage medium 120 is, for example, any form of fixed or movable random access memory (RAM), a read-only memory (ROM), a flash memory, a hard disk drive (HDD), a solid state drive (SSD), or a similar element, or a combination thereof, used to store a plurality of modules or various application programs that may be executed by the processor 110. In an embodiment, the storage medium 120 may pre-store a machine learning model for image recognition.

The display 130 may include a liquid-crystal display (LCD) or an organic light-emitting diode (OLED) display. In an embodiment, the display 130 may provide an image beam to the user's eyes to form an image on the user's retina, so that the user may see the XR scene created by the head-mounted display 100.

The image capture device 140 is, for example, a camera used to capture images. The image capture device 140 may include a photosensitive element such as a complementary metal oxide semiconductor (CMOS) or a charge coupled device (CCD). In an embodiment, the image capture device 140 may be a depth camera and may obtain depth information of the captured image.

The speaker 150 is, for example, a moving coil type speaker, an electromagnetic speaker, or a piezoelectric speaker. The speaker 150 may receive audio signals from the processor 110, convert the audio signals into sound waves, and output the sound waves.

FIG. 2 is a flowchart of a method for compensating audio data according to an embodiment of the disclosure, where the method may be implemented by the head-mounted display 100 shown in FIG. 1. In step S201, the processor 110 may obtain audio. For example, assuming that the head-mounted display 100 is providing an AR scene to the user, the processor 110 may obtain audio corresponding to a virtual sound source in the AR scene.

In step S202, the processor 110 may capture an image of the field of the user through the image capture device 140.

In step S203, the processor 110 may perform image recognition on the image according to the machine learning model to obtain field type information. The processor 110 may input the image to the machine learning model, so that the machine learning model outputs the field type information. The field type information may include, but is not limited to, the field type of the user (for example, a bathroom or a conference room) or the material of the sound reflector (for example, metal or glass).

In an embodiment, the processor 110 may train the machine learning model according to an unsupervised learning algorithm and store the machine learning model in the storage medium 120. In an embodiment, the processor 110 may train the machine learning model according to a supervised learning algorithm and store the machine learning model in the storage medium 120. Specifically, the processor 110 may obtain a plurality of historical images, where each of the plurality of historical images is tagged with historical field type information. The processor 110 may train the machine learning model according to the plurality of historical images tagged with the historical field type information, and store the trained machine learning model in the storage medium 120.

In step S204, the processor 110 may measure the field of the user through the image capture device 140 to obtain depth information.

In step S205, the processor 110 may calculate the size of the field according to the depth information. Specifically, the processor 110 may execute a simultaneous localization and mapping (SLAM) algorithm according to the depth information to obtain grid information, and calculate the size of the field according to the grid information.

After obtaining the field type information and the size of the field, in step S206, the processor 110 may select the room impulse response according to the field type information of the field and/or the size of the field.

Specifically, the storage medium 120 may store a plurality of different room impulse responses, where the room impulse responses are, for example, defined according to experimental results. The storage medium 120 may also store a lookup table associated with the room impulse response. The lookup table may contain a mapping relationship between the room impulse response and the field type information, or it may contain a mapping relationship between the room impulse response, the field type information, and the size. After obtaining the field type information and/or the size, the processor 110 may query the lookup table according to the field type information and/or the size to obtain the corresponding room impulse response. That is, the processor 110 may select a specific room impulse response from a plurality of room impulse responses according to the field type information and/or the size.

For example, assume that the user is in a conference room. The processor 110 may determine the field type information (for example, a wall made of glass) and/or the size of the conference room according to the image captured by the image capture device 140. The processor 110 may use the field type information and/or the size to select the room impulse response corresponding to the conference room (or conference room with a specific size) from the lookup table.

In step S207, the processor 110 may process the audio according to the selected room impulse response to generate processed audio. Specifically, processor 110 may perform convolution on the audio and the selected room impulse response to generate the processed audio. The processed audio may have acoustic properties that match the field of the user.

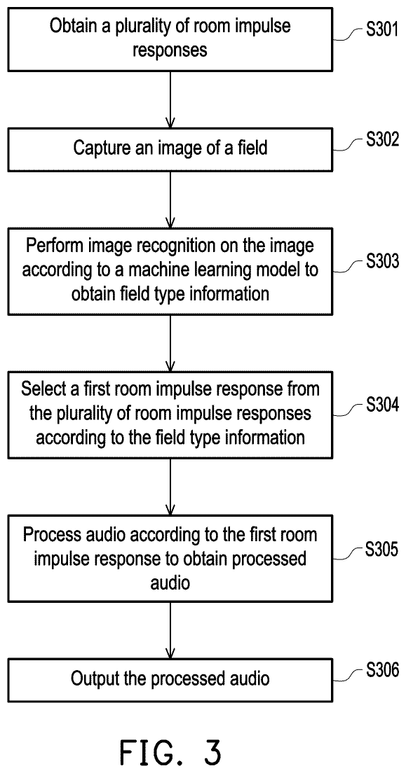

FIG. 3 is a flowchart of a method for compensating audio data according to another embodiment of the disclosure, where the method may be implemented by the head-mounted display 100 shown in FIG. 1. In step S301, a plurality of room impulse responses are obtained. In step S302, an image of the field is captured. In step S303, image recognition is performed on the image according to the machine learning model to obtain field type information. In step S304, a first room impulse response is selected from the plurality of room impulse responses according to the field type information. In step S305, the audio is processed according to the first room impulse response to obtain processed audio. In step S306, the processed audio is output.

To sum up, the head-mounted display of the disclosure may perform image recognition for the field of the user to determine the type of field. The head-mounted display selects an appropriate room impulse response according to the field type and processes the audio from the virtual sound source using the selected room impulse response to generate realistic processed audio. In this way, no matter where the head-mounted display is used in any field, the head-mounted display may correctly compensate the audio data.

What is claimed is:

1. A head-mounted display for compensating audio data, comprising:
a storage medium, storing a plurality of room impulse responses;
an image capture device, capturing an image of a field;
a speaker; and
a processor, coupled to the storage medium, the image capture device, and the speaker, wherein the processor is configured to execute:
performing image recognition on the image according to a machine learning model to obtain field type information;
selecting a first room impulse response from the plurality of room impulse responses according to the field type information;
processing audio according to the first room impulse response to generate processed audio; and
outputting the processed audio through the speaker.

2. The head-mounted display according to claim 1, wherein the processor is configured to further execute:
measuring a size of the field through the image capture device; and
selecting the first room impulse response from the plurality of room impulse responses according to the size and the field type information.

3. The head-mounted display according to claim 2, wherein the processor is configured to further execute:
measuring the field through the image capture device to obtain depth information;
executing a simultaneous localization and mapping algorithm according to the depth information to obtain grid information; and
calculating the size of the field according to the grid information.

4. The head-mounted display according to claim 1, wherein the processor is configured to further execute:
performing convolution on the audio and the first room impulse response to generate the processed audio.

5. The head-mounted display according to claim 1, wherein the field type information comprises a material of a sound reflector.

6. The head-mounted display according to claim 1, wherein the processor is configured to further execute:
receiving a plurality of historical images, wherein each of the plurality of historical images is tagged with historical field type information; and
training the machine learning model according to the plurality of historical images.

7. A method for compensating audio data, comprising:
obtaining a plurality of room impulse responses;
capturing an image of a field;
performing image recognition on the image according to a machine learning model to obtain field type information;
selecting a first room impulse response from the plurality of room impulse responses according to the field type information;
processing audio according to the first room impulse response to obtain processed audio; and
outputting the processed audio.

8. The method according to claim 7, wherein the step of selecting the first room impulse response from the plurality of room impulse responses according to the field type information comprises:
measuring a size of the field through an image capture device; and
selecting the first room impulse response from the plurality of room impulse responses according to the size and the field type information.

9. The method according to claim 8, wherein the step of measuring the size of the field through the image capture device comprises:
measuring depth information of the field through the image capture device;
executing a simultaneous localization and mapping algorithm according to the depth information to obtain grid information; and
calculating the size of the field according to the grid information.

10. The method according to claim 7, wherein the step of processing the audio according to the first room impulse response to obtain the processed audio comprises:
performing convolution on the audio and the first room impulse response to generate the processed audio.

11. The method according to claim 7, wherein the field type information comprises a material of a sound reflector.

12. The method according to claim 7, further comprising:
receiving a plurality of historical images, wherein each of the plurality of historical images is tagged with historical field type information; and
training the machine learning model according to the plurality of historical images.
